(19) United States
(12) Patent Application Publication
(10) Pub. No.: US 2008/0132569 A1
(43) Pub. Date: Jun. 5, 2008

(54) Antifungal Compositions for Inhibiting Growth of Wood Decay Fungi and Use Thereof

(75) Inventors: Shang-Tzen Chang, Taipei City (TW); Fu-Lan Hsu, Taipei City (TW); Hui-Ting Chang, Taipei City (TW); Tsair-Bor Yen, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL TAIWAN UNIVERSITY, Taipei City (TW)

(21) Appl. No.: 11/944,047

(22) Filed: Nov. 21, 2007

(30) Foreign Application Priority Data
Dec. 5, 2006 (TW) 095145068

(51) Int. Cl. A01N 37/10; A01N 35/00; A01P 3/00; D21H 21/36

(52) U.S. Cl. 514/532; 162/161; 514/574; 514/701

(57) ABSTRACT

The present invention is related to an antifungal composition for inhibition of wood decay caused by wood rot fungi. The invention further comprises a method for inhibition of wood decay with gallates.

### FIELD OF THE INVENTION

The present invention is related to the field of an antifungal composition for inhibition of lignocellulosic material decay. This invention further relates to a method for inhibition of lignocellulosic material decay.

### BACKGROUND OF THE INVENTION

Lignocellulosic material possesses many good characteristics and has been utilized widely in our daily life since ancient time. Lignocellulosic material is defined as wood products, furniture, wooden objects, wood composites, wood-based cultural relics, paper and paper board, paper-based materials, paper-based cultural relices, bamboo products, bamboo-based cultural relics. Wood composed of cellulose, hemicelluloses, and lignin, not only provides a good nutritional source for microbes and insects but a suitable habitat because of its hydrophilic functional group and porous property. Under hot and humid climatic conditions in Taiwan, lignocellulosic material is very easy to be attacked by living creatures, especially various fungi, causing huge impact on economy and natural resource loss.

In order to extend the servicelife of lignocellulosic products, various preservatives have been developed for treating lignocellulosic material. Due to the elevation of environmental awareness, most of the widely used preservatives could not meet users' expectation. A great preservative, chromated copper arsenate (CCA) compounds, is under strict regulation of production and application in many countries due to its heavy metal content such as chromium and arsenate which are human carcinogens as well as environmental pollutants. Currently, most alternative preservatives of CCA still use heavy metal copper (copper-organic mixture) for its anti-microorganism activity, such as alkaline copper quaternary ammonium compounds (ACQ), or ammoniacal copper azole (CuAz) compounds. Although the heavy metal of these compounds is less toxic, the impact to our environment still comes along with its waste. It all adds up to the processing cost eventually. These alternative preservatives of CCA also have some disadvantages such as highly corrosive to metal equipments. Besides, some strains of fungi causing wood damage are highly tolerant to copper. Therefore, the latest preservatives still can not inhibit lignocellulosic material decay completely.

In order to eliminate the disadvantage of current preservatives such as non-environmental friendliness and inability to inhibit copper tolerant fungi, this invention provides an environmental friendly method and composition to inhibit lignocellulosic material decay caused by fungal infection.

### SUMMARY OF THE INVENTION

The present invention relates to a chemical composition for inhibition of lignocellulosic material decay caused by fungal infection.

This invention further comprises a method of application of an antifungal composition for inhibition of lignocellulosic material decay, especially caused by wood decay fungi.

### BRIEF DESCRIPTION OF THE DRAWINGS

FIG. 1 shows the inhibition effect of cinnamaldehyde (black bar) and octyl gallate (white bar) against four strains of wood decay fungi: L. betulina, T. versicolor, G. trabeum and L. sulphureus. (A) a bar graph indicating IC₅₀ value (the concentration in that inhibited 50% of the mycelium growth). (B) a bar graph indicating IC₉₀ value (the concentration in that inhibited 90% of the mycelium growth).

FIG. 2 shows the antifungal activity of cinnamaldehyde and/or octyl gallate against two strains of wood decay fungi: (A) L. betulina, and (B) G. trabeum. Cin50: cinnamaldehyde at the concentration of 50 μg/ml. OG25: octyl gallate at the concentration of 25 μg/ml. OG100: octyl gallate at the concentration of 100 μg/ml.

FIG. 3 shows the antifungal activity of cinnamaldehyde and/or EDTA against (A) L. sulphureus and (B) L. betulina. Cin50: cinnamaldehyde at the concentration of 50 μg/ml. EDTA 30: EDTA at the concentration of 30 μg/ml.

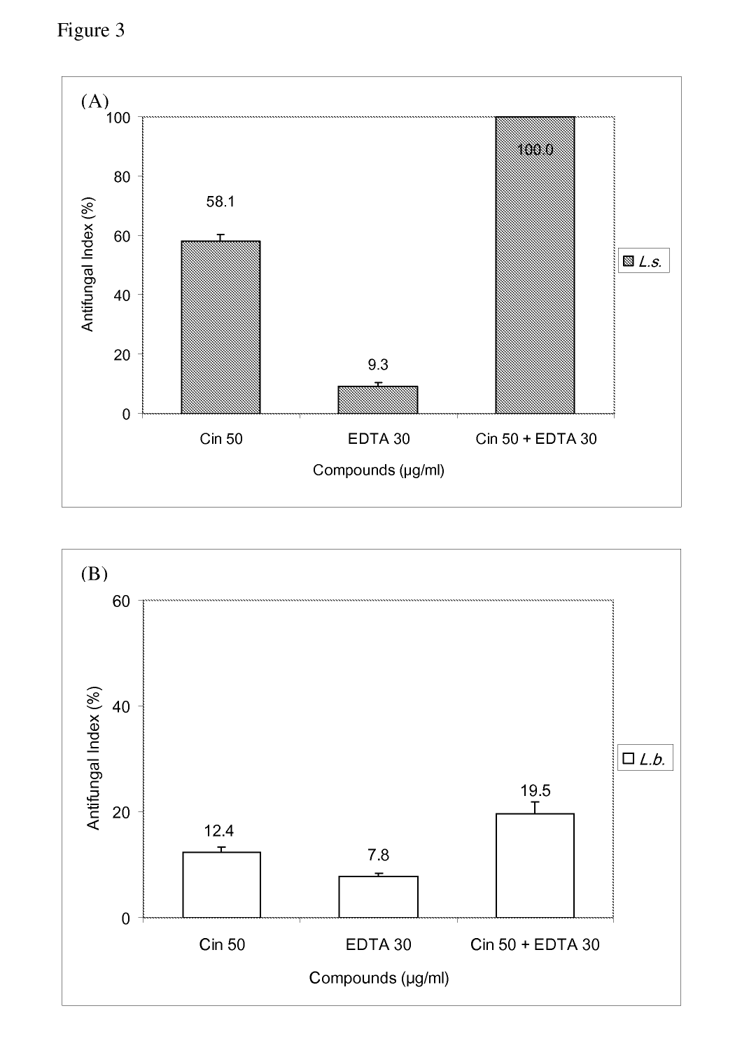

### DETAILED DESCRIPTION OF THE INVENTION

The purpose of the present invention is to provide an environmental friendly composition which does not contain chromium, arsenate or copper and can be used a wide spectrum lignocellulosic material preservative against various lignocellulosic material decay fungi. Most of the microbes that cause lignocellulosic material decay described in the present invention belong to the phyla Basidiomycota and Ascomycota. They are further classified as brown-rot fungi such as Coriolellus palustris (JIS), Coniophora puteana (EN), Poria placenta (ASTM), Paxillus panuoides and Serpula lacrymans; white-rot fungi such as Bjerkanderna adusta, Ceraceomerulius serpens, Phanerochaete chrysosporium, Phlebiopsis gigantean, Schizophyum commune and Phlebia subseralis; and soft rot fungi such as Aspergillus terreus, Aspergillus niger, Chaetomium globosum, Myrothecium verrucaria, Trichoderma lignorum, Penicillium citrinum, Aspergillus clavatus and Memnoniella echinata.

The problems of current lignocellulosic material preservatives are causing environmental pollution and their inability to inhibit copper tolerant wood decay fungi. The present invention provides a solution to solve these problems. This invention provides an antifungal composition for inhibition of lignocellulosic material decay, which comprises application of low toxic alkyl gallates alone or combined with compounds such as cinnamaldehyde or diaminoethanetetraacetic acid (EDTA) as a mixture to inhibit the growth of various wood decay fungi. This invention provides an antifungal composition for inhibition of lignocellulosic material decay, which comprises application of cinnamaldehyde or similar compounds alone or combined with compounds such as eugenol or EDTA. These compounds are dissolved in organic solvent such as ethanol.

The mycelium growth of lignocellulosic material decay fungi can be inhibited after treating with alkyl gallate alone or that with compounds such as cinnamaldehyde or EDTA as well as treating with cinnamaldehyde or similar compounds alone or that with eugenol or EDTA. The present invention can serve as an excellent alternative chemical composition to decrease the demand of current heavy metal wood preservatives and to alleviate the environmental impact. Also, this invention can inhibit copper tolerant wood decay fungi which can not be achieved by current heavy metal wood preservatives.

Accordingly, the present invention relates to an anti-fungal composition for inhibition of lignocellulosic material decay, comprising a compound of formula I:

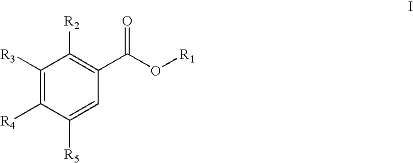

wherein R₁ is (CH₂)ₙCH₃, n=2˜11; R₂ is H or OH; R₃ is OCH₃, H or OH; R₄ is OCH₃, H or OH; and R₅ is H or OH.

In preferred embodiment, the compound of formula I wherein n=7; R₂ is H; R₃ is OH; R₄ is OH and R₅ is OH.

In another preferred embodiment, the compound of formula I wherein n=2; R₂ is H; R₃ is OH; R₄ is OH and R₅ is OH.

The composition can further comprise cinnamaldehyde or EDTA in addition to the compound of formula I and result in synergistic antifungal effect.

The compound of formula I is dissolved in an organic solvent. In preferred embodiments, the organic solvent is ether or alcohol such as ethanol and the compound is dissolved to obtain the final concentration of 0.5˜1000 μg/ml.

The present invention also relates to an anti-fungal composition for inhibition of lignocellulosic material decay, comprising a compound of formula II

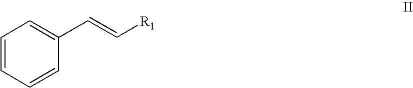

wherein R₁ is CH₂OH, CH₂OCOCH₃, CHO or COOH.

In preferred embodiment, the compound of formula II wherein R₁ is CHO.

The composition can further comprise eugenol or EDTA in addition to the compound of formula II and result in synergistic antifungal effect.

The present invention also relates to a method for inhibition of lignocellulosic material decay caused by fungal infection, which comprises administering to a lignocellulosic material an effective amount of a composition, comprising a compound of formula I

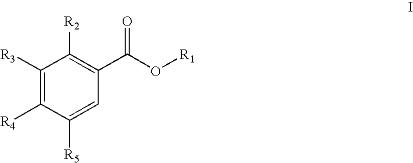

wherein R₁ is (CH₂)ₙCH₃, n=2˜11; R₂ is H or OH; R₃ is OCH₃, H or OH; R₄ is OCH₃, H or OH; and R₅ is H or OH.

In preferred embodiments, wherein n=7; R₂ is H; R₃ is OH; R₄ is OH; and R₅ is OH.

In another preferred embodiments, wherein n=2; R₂ is H; R₃ is OH; R₄ is OH; and R₅ is OH.

The composition can further comprise cinnamaldehyde or EDTA in addition to the compound of formula I and result in synergistic antifungal effect.

In preferred embodiments, wherein the lignocellulosic material is an antique made by lignocellulosic materials.

In the present invention the fungal infection is mostly caused by fungi in the phyla of Basidiomycota or Ascomycota.

The present invention also relates to a method for inhibition of lignocellulosic material decay caused by fungal infection, which comprises administering to a lignocellulosic material an effective amount of a composition, comprising a compound of formula II

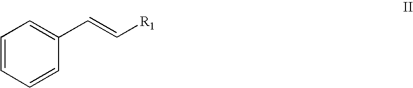

wherein R₁ is CH₂OH, CH₂OCOCH₃, CHO or COOH.

In preferred embodiments, wherein R₁ is CHO.

The composition can further comprise eugenol or EDTA in addition to the compound of formula II and result in synergistic antifungal effect.

In preferred embodiments, wherein the lignocellulosic material is an antique made by lignocellulosic materials.

In preferred embodiments, wherein the fungal infection is caused by fungi in the phyla of Basidiomycota or Ascomycota.

The effective amount of the chemical composition of the present invention is alkyl gallate at a concentration of 0.5˜1000 μg/ml. A suitable application is to dissolve alkyl gallate in organic solvent. A more suitable application is to dissolve alkyl gallate in alcohol or ether. The most suitable application is to dissolve alkyl gallate in ethanol.

In preferred embodiments, the chemical composition of alkyl gallate further comprises disinfectant, such as cinnamaldehyde, eugenol, alpha-cadinol, carvacrol, T-muurolol, T-cadinol, gamma-cadinene, cyptomeridiol, tropolones, pinosylvin, resveratrol, dihydromorin, and/or ferruginol.

In preferred embodiments, the chemical composition of alkyl gallate may also comprise antioxidant or metal chelator.

The following examples illustrate the present inventions and are not limited to the same.

### EXAMPLES

### Example 1

### Anti-Fungal Activity of Antioxidants (Propyl Gallate, Octyl Gallate and Butylated Hydroxyltoluene) and Cinnamaldehyde

### Fungal Strains

Fungal strains used were two white-rot fungi: Lenzites betulina (BCRC 35296) and Trametes versicolor (BCRC 35253) and two brown-rot fungi: Laetiporus sulphureus (BCRC 35305) and Gloeophyllum trabeum (BCRC 31614).

### Chemicals

Propyl gallate and octyl gallate were purchased from Tokyo Kasei Kogyo Co. (Japan). Butylated hydroxyltoluene (BHT) and 1-diphenyl-2-picrylhydrazyl (DPPH) were purchased from Sigma Chemical Co. (America). Cinnamaldehyde was purchased from ACROS (Belgium). Commercial fungicide propiconazole was used as a positive control.

### Media Preparation and Growth Condition

Potato dextrose agar (PDA) was mixed with distilled water at a concentration of 39 g/l and then autoclaved. Various chemicals such as propiconazole, propyl gallate, octyl gallate and cinnamaldehyde were dissolved in ethanol before adding into autoclaved PDA media.

After transferring the mycelia of fungal strains onto PDA containing various chemicals, the media were incubated in the dark at 27±2° C. and with 70% relative humidity till the fungal mycelium reached the edges of the control dishes.

### Antifungal Assays

Antifungal assays were performed based on Chang et al. (Holzforschung 1999, 53:487-490; Holzforschung 2000, 54:241-245) with slight modifications. Propiconazole, cinnamaldehyde, propyl gallate and octyl gallate were dissolved in ethanol; BHT was dissolved in ethanol containing 1% Tween. Chemicals were added into autoclaved PDA media at various concentrations. When the mycelium of fungi reached the edges of the control dishes, the antifungal indices (AI %) were calculated. Each test was repeated three times and the average was calculated. The formula to calculate antifungal index was shown as follows:

Antifungal index(AI, %)=(1−Da/Db)×100

### Da is the diameter of growth zone in the experimental dish (cm) and Db is the diameter of growth zone in the control dish (cm).

### The IC₅₀ values (the concentration in that inhibited 50% of the mycelium growth) were calculated by probit analysis.

### The IC₉₀ values (the concentration in that inhibited 90% of the mycelium growth) were calculated by probit analysis.

### Antifungal index (%) of test compounds against four wood decay fungi

The anti-fungal activities of samples are shown in Table 1. Among all samples tested, the commercial fungicide, propiconazole, was the most effective with an antifungal index of 100% against L. betulina and L. sulphureus at the concentration of 1 μg/ml. At the concentration of 100 μg/ml, octyl gallate exhibited stronger antifungal activity against all fungi than other two antioxidants, propyl gallate and BHT. Octyl gallate also exhibited stronger antifungal activity against T. versicolor, G. trabeum and L. sulphureus than cinnamaldehyde.

TABLE 1
Antifungal index (%) of test compounds against four wood
decay fungi at the concentration of 100 μg/ml.

| | Wood decay fungi | | | |
|---|---|---|---|---|
| | L. | T. | G. | L. |
| Compounds | betulina | versicolor | trabeum | sulphureus |
| Propiconazole^{a} | 100 ± 0 | 92 ± 0.6 | 52 ± 3.7 | 100 ± 0 |
| Cinnamaldehyde | 100 ± 0 | 34 ± 2.2 | 31 ± 0.7 | 100 ± 0 |
| Octyl gallate | 43 ± 2.5 | 69 ± 9.1 | 85 ± 26.2 | 100 ± 0 |
| Propyl gallate | 1 ± 1.9 | 0 ± 0 | 2 ± 0.6 | 0 ± 0 |
| BHT | 16 ± 3.4 | 23 ± 2.6 | 0 ± 0 | 21 ± 5.6 |

^{a}The concentration of propiconazole was 1 μg/ml.

### IC₅₀ and IC₉₀ Value of Cinnamaldehyde or Octyl Gallate Against Four Wood Decay Fungi

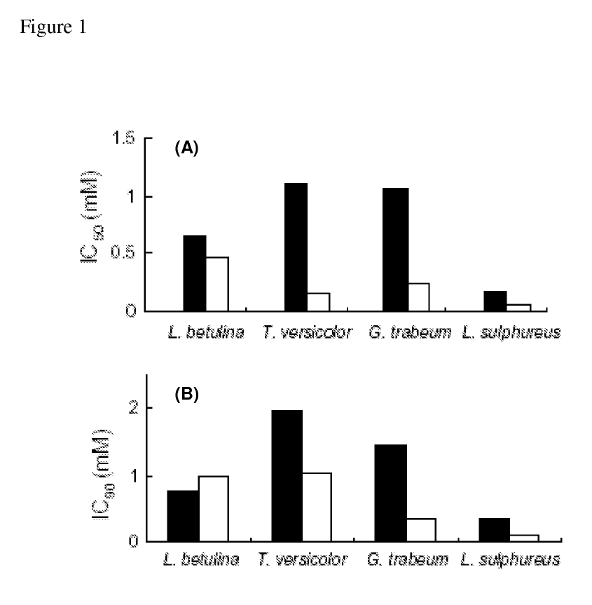

The IC₅₀ and IC₉₀ values obtained for octyl gallate and cinnamaldehyde against four decay fungi are shown in FIG. 1. The IC₅₀ values of cinnamaldehyde were 0.65, 1.11, 1.05, and 0.17 mM against L. betulina, T. versicolor, G. trabeum and L. sulphureus, respectively, while the IC₅₀ values of octyl gallate against these four fungi was 0.47, 0.16, 0.24 and 0.04 mM, respectively [FIG. 1 (A)]. This result clearly showed that octyl gallate had better antifungal property than cinnamaldehyde. As for IC₉₀, octyl gallate was also more effective than cinnamaldehyde for growth inhibition of T. versicolor, G. trabeum and L. sulphureus, but not for L. betulina [FIG. 1 (B)].

### Example 2

### Antifungal Activity of Octyl Gallate Alone

The strains used in this experiment include soft rot fungi [Chaetomium globosum (BCRC31605)], Cu tolerant rot fungi [Wolfiporia extensa (BCRC36022), Poria placenta (BCRC36412)], brown rot fungi [Laetiporus sulphureus (BCRC35305), Gloeophyllum trabeum (BCRC31614), Formitopsis pinicola (BCRC35303), Antrodia taxa] and white rot fungi [Lenzites betulina (BCRC35296), Trametes versicolor (BCRC35253), Schizophyllum commune (BCRC35258)].

The antifungal index (AI %) and median inhibition concentration (IC₅₀) were measured as described before.

As shown of AI value in Table 2 and IC₅₀ value in Table 3, at the concentration of 100 μg/ml, octyl gallate could inhibit the growth of C. globosum and A. taxa completely, while showing 75˜96% inhibition against W. extensa, P placenta, L. sulphureus, G. trabeum and F. pinicola. Octyl gallate also showed 41˜69% inhibition ability against L. betulina, T versicolor and S. commune at the concentration of 100 μg/ml. The IC₅₀ value of octyl gallate against soft rot, Cu tolerant, and brown rot fungi was less than 50 μg/ml; the IC₅₀ value of octyl gallate against white rot fungi was also less than 200 μg/ml. In other words, octyl gallate is great to inhibit wide spectrum of wood rot fungi. Octyl gallate can extend its lifespan of wood product, also fit to the environmental standard because of its low toxicity to the environment and human beings.

TABLE 2
Antifungal index (%) of octyl gallate against various fungal strains at
different concentrations (μg/ml).

| | Soft | | | | | | | | | |
|---|---|---|---|---|---|---|---|---|---|---|
| | rot | Cu tolerant | | | | | | | | |
| | fungi | fungi | | Brown rot fungi | | | | White rot fungi | | |
| | C. | W. | P. | L. | G. | F. | A. | L. | T. | S. |
| Conc. | globosum | extensa | placenta | sulphureus | trabeum | pinicola | taxa | betulina | versicolor | commune |
| 25 | 82 | 3 | 58 | — | — | 52 | 73 | 16 | 37 | 16 |
| 50 | 100 | 50 | 75 | 85 | 49 | 78 | 100 | 28 | 50 | 40 |
| 100 | 100 | 75 | 82 | 96 | 77 | 94 | 100 | 41 | 69 | 60 |
| 200 | 100 | 64 | 84 | 100 | 93 | 100 | 100 | 88 | 85 | 83 |

TABLE 3
IC₅₀ value (μg/ml) of octyl gallate against various wood decay fungi.

| Soft rot | Cu tolerant | | | | | | | | |
|---|---|---|---|---|---|---|---|---|---|
| fungi | fungi | | Brown rot fungi | | | | White rot fungi | | |
| C. | W. | P. | L. | G. | F. | A. | L. | T. | S. |
| globosum | extensa | placenta | sulphureus | trabeum | pinicola | taxa | betulina | versicolor | commune |
| <25 | 50 | <25 | 50.6 | 50.8 | <25 | <25 | 137.6 | 173 | 114 |

### Example 3

### Synergistic Antifungal Effects of the Combination of Octyl Gallate with Cinnamaldehyde

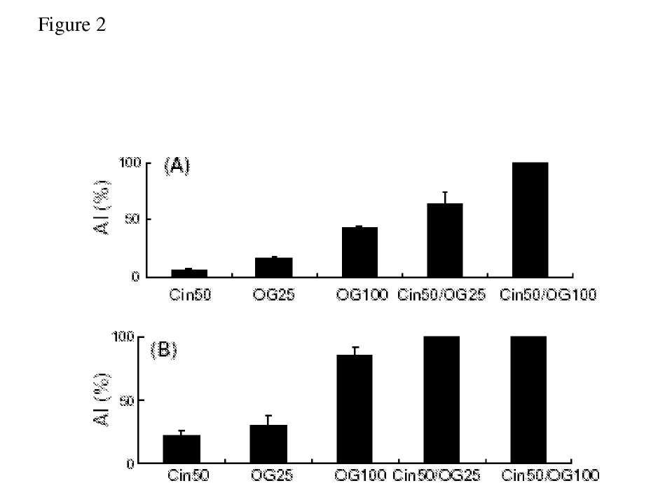

Antioxidants combined with cinnamaldehyde were studied to determine whether the combination has enhanced actions against wood decay fungi. The antifungal index (AI %) was calculated as described above. As shown in FIG. 2, the tested fungi were L. betulina (A) and G. trabeum (B). Octyl gallate (OG) and/or cinnamaldehyde (Cin) were used to treat wood decay fungi in various combinations. Cin50 indicated the concentration of cinnamaldehyde was 50 μg/ml, and OG25 indicated the concentration of octyl gallate was 25 μg/ml.

The antifungal index of cinnamaldehyde against L. betulina at the concentration of 50 μg/ml was 6% and that of octyl gallate against L. betulina at the concentration of 25 and 100 μg/ml was 16% and 42%, respectively. The antifungal index for the treatment using the combination of cinnamaldehyde with octyl gallate was greatly increased to 64% and 100%, respectively, indicating that the cinnamaldehyde/octyl gallate combination had significant synergism against L. betulina.

The same synergistic effect was also observed for G. trabeum. The antifungal index of cinnamaldehyde against G. trabeum at the concentration of 50 μg/ml was 22% and that of octyl gallate against G. trabeum at the concentration of 25 μg/ml was 30%. The antifungal index for the treatment using the combination of cinnamaldehyde with octyl gallate was greatly increased to 100%. In other words, the combination of octyl gallate and cinnamaldehyde has great inhibition effect against wood decay fungi. The combination can reach the similar effect even with less amounts of chemicals. Besides, wood treatment with low toxic octyl gallate and cinnamaldehyde can not only extend the lifespan of wood products, but also meet our need for the environment and public health.

### Example 4

### Synergistic Antifungal Effect of Cinnamaldehyde in Combination with Eugenol Against Wood Decay Fungi

The fungal strains used were white-rot fungus, Lenzites betulina (BCRC 35296) and brown-rot fungus, Laetiporus sulphureus (BCRC 35305). 1-Diphenyl-2-picrylhydrazyl (DPPH) and ascorbic acid were purchased from Sigma Chemical Co. (USA). Cinnamaldehyde, eugenol, catechin and quercetin were purchased from ACROS (Belgium). Commercial fungicide propiconazole was used as a positive control.

Antifungal assays were performed as described before with slight modifications. Cinnamaldehyde, catechin, quercetin, eugenol and propiconazole were dissolved in ethanol. Solutions of serial concentrations of chemicals were mixed with sterilized potato dextrose agar (PDA) in Petri dish (9 cm dia.) containing 15 ml agar. After inoculating the mycelia of fungus onto the center of agar, the dishes were incubated in the dark at 27±2° C. and 70% relative humidity. When the mycelium of fungi reached the edges of the control dishes, the antifungal indices were calculated as described before.

Minimal inhibitory concentrations (MICs) were also examined using the methods reported by Kubo and Lee (J. Agric. Food Chem. 1998, 46:4052-4055) with slight modifications. The testing dishes were incubated under the same growth conditions as above. When the mycelium of fungi reached the edges of the control dishes, the lowest concentration with no sign of growth was defined as MIC. After the MIC was determined, a small piece of agar (2×2×2 mm³) was taken from the colony of the MIC plate, and was inoculated on a drug-free PDA medium. After 5 days, minimum fungicidal concentrations (MFCs) were determined by the lowest concentration of the test compounds in which no recovery of microorganism was observed.

The antifungal activities of test compounds were first examined at the concentration of 100 μg/ml, and the results are shown in Table 4. Among all compounds tested, the commercial fungicide, propiconazole, was the most effective and completely inhibited the growth of L. betulina and L. sulphureus at the concentration of 1 μg/ml. Cinnamaldehyde and eugenol also exhibited strong antifungal activities with antifungal index of 100% against both L. betulina and L. sulphureus, while catechin and quercetin did not express antifungal activities at the same concentration.

TABLE 4
Antifungal index (%) of test compounds against wood decay
fungi at the concentration of 100 μg/ml

Fungi

| Compounds | L. betulina | L. sulphureus |
|---|---|---|
| Cinnamaldehyde | 100 ± 0.0^{a} | 100 ± 0.0^{a} |
| Catechin | 3 ± 1.5^{b} | 5 ± 1.8^{b} |
| Quercetin | 0 ± 0.0^{b} | 0 ± 0.0^{c} |
| Eugenol | 100 ± 0.0^{a} | 100 ± 0.0^{a} |
| Propiconazole* | 100 ± 0.0^{a} | 100 ± 0.0^{a} |

*Concentration of propiconazole was 1 μg/ml as a positive control. Results are mean ± SE (n = 5). Means in bars with different superscript letters are significant different at alpha level of 0.05.

The IC₅₀ and IC₉₀ values for individual compound were further determined, and the results obtained for cinnamaldehyde, eugenol, catechin and quercetin against two wood decay fungi are shown in Table 5. The IC₅₀ values of cinnamaldehyde were 0.65 and 0.23 mM against L. betulina and L. sulphureus, respectively. Among these three antioxidants, only eugenol showed excellent antifungal activities against L. betulina and L. sulphureus with IC₅₀ of 0.37 and 0.25 mM, respectively. On the contrary, catechin and quercetin revealed very limited inhibitory effects against L. betulina and L. sulphureus. As for IC₉₀, the similar results were found that both cinnamaldehyde and eugenol exhibited much stronger antifungal activities against L. betulina and L. sulphureus than those of catechin and quercetin.

TABLE 5
IC₅₀ and IC₉₀ values of test compounds and in
combinations with cinnamaldehyde against wood decay fungi

| | L. betulina | | L. sulphureus | |
|---|---|---|---|---|
| Compounds | IC₅₀ (mM) | IC₉₀ (mM) | IC₅₀ (mM) | IC₉₀ (mM) |
| Cinna- | 0.65 ± 0.03^{b} | 0.72 ± 0.06^{b} | 0.23 ± 0.02^{b} | 0.53 ± 0.02^{b} |
| maldehyde | | | | |
| Eugenol | 0.37 ± 0.02^{a} | 0.65 ± 0.05^{a} | 0.25 ± 0.03^{b} | 0.52 ± 0.01^{b} |
| Catechin | >100^{e} | >100^{e} | 40 ± 0.12^{c} | 80 ± 0.14^{c} |
| Quercetin | >100^{e} | >100^{e} | 64 ± 0.25^{d} | >100^{d} |
| Cin. + eugenol | 0.38 ± 0.02^{a} | 0.63 ± 0.04^{a} | 0.18 ± 0.01^{a} | 0.37 ± 0.02^{a} |
| Cin. + catechin | 1.22 ± 0.04^{c} | 1.40 ± 0.09^{c} | 0.23 ± 0.04^{b} | 0.52 ± 0.04^{b} |
| Cin. + | 1.44 ± 0.06^{d} | 1.65 ± 0.07^{d} | 0.26 ± 0.02^{b} | 0.53 ± 0.03^{b} |
| quercetin | | | | |

Results are mean ± SE (n = 5). Means in column with different superscript letters are significant different at alpha level of 0.05.
Cin.: cinnamaldehyde.

The combined effects of cinnamaldehyde with eugenol, catechin or quercetin were evaluated by comparing the isoeffective concentrations (IC₅₀ and IC₉₀) of test compounds and designated combinations. It was considered synergy when the isoeffective concentration of combination was significantly lower than those of compounds acting alone. Cinnamaldehyde with eugenol, catechin or quercetin were prepared at 1:1 ratio in molarities with serial concentrations for assaying, and the values of IC₅₀ and IC₉₀ were given in Table 5.

Significant synergy was observed on the combination of cinnamaldehyde with eugenol against L. sulphureus. The antifungal index of cinnamaldehyde against L. sulphureus at the concentration of 0.17 mM was 41%, and that of eugenol at the same concentration was 24%, while the antifungal index of combination using cinnamaldehyde and eugenol against L. sulphureus dramatically increased to 90%, indicating portent of synergistic effect. The synergy was further confirmed by comparing their isoeffective concentrations. The values of IC₅₀ and IC₉₀ for the combination of cinnamaldehyde with eugenol against L. sulphureus were 0.18 and 0.37 mM, respectively, which were significantly lower than those of using either cinnamaldehyde or eugenol alone. However, only additive effect was found on the combination of cinnamaldehyde and eugenol against L. betulina with IC₅₀ (0.38 mM) and IC₉₀ (0.63 mM). In addition, the combinations of cinnamaldehyde with catechin or quercetin against L. sulphureus also exhibited additive effects, but both combinations showed marked antagonistic effects against L. betulina. The values of IC₅₀ and IC₉₀ for the combination of cinnamaldehyde with catechin against L. betulina were 1.22 and 1.40 mM, and against L. sulphureus were 0.23 and 0.52 mM, respectively. Among all samples tested, the strongest antagonistic effect was discovered on the combination of cinnamaldehyde and quercetin against L. betulina with IC₅₀ (1.44 mM) and IC₉₀ (1.65 mM) which were significantly higher than those of cinnamaldehyde alone.

Furthermore, the values of MIC and MFC for cinnamaldehyde and eugenol alone and their combination were determined. The results, as seen in Table 6, showed that strong synergism was also observed for the combination of cinnamaldehyde and eugenol against L. sulphureus with significantly lower values of MIC (0.40 mM) and MFC (0.40 mM) than that of cinnamaldehyde or eugenol alone. However, this combination only revealed additive effect against L. betulina with MIC (0.68 mM) and MFC (0.68 mM) which were no different to MIC and MFC values of cinnamaldehyde or eugenol. The same values of MIC and MFC for the combination of cinnamaldehyde with eugenol also showed it was fungicidal instead of fungistatic.

From the results, it could be concluded that the combination of cinnamaldehyde with eugenol showed excellent antifungal properties, and the strong synergy was also observer against L. sulphureus on the basis of IC₅₀, IC₉₀, MIC or MFC.

TABLE 6
MIC and MFC values of cinnamaldehyde, eugenol and
their combination against two wood decay fungi

| | L. betulina | | L. sulphureus | |
|---|---|---|---|---|
| Compounds | MIC (mM) | MFC (mM) | MIC (mM) | MFC (mM) |
| Cinna- | 0.75 | 0.75 | 0.70 | 0.70 |
| maldehyde | | | | |
| Eugenol | 0.70 | 0.70 | 0.65 | 0.65 |
| Cin. + eugenol | 0.68 | 0.68 | 0.40 | 0.40 |

Cin.: cinnamaldehyde.

### Example 5

### Synergistic Antifungal Effects of the Metal Chelator EDTA and Cinnamaldehyde

The fungal strains used were Lenzites betulina and Laetiporus sulphureus.

EDTA along exhibited strong antifungal activity against Lenzites betulina with antifungal index of 90% at the concentration 50 μg/ml. On the contrary, at the same concentration EDTA revealed very weak antifungal activity against Laetiporus sulphureus with antifungal index of 10%. When the concentration was reduced to 30 μg/ml, EDTA showed a similar inhibitory effect against both L. betulina and L. sulphureus. EDTA was further tested its combination effect with cinnamaldehyde. When EDTA was used with cinnamaldehyde, the combination performed dramatically better against L. sulphureus than either EDTA or cinnamaldehyde along, indicating synergistic effect. However, only additive effect was observed on the combination of EDTA and cinnamaldehyde against L. betulina. The results above indicated that the antifungal activities of EDTA were on the extremely two ends. For the fungal strain like L. sulphureus which is not effectively inhibited by EDTA, the combination of EDTA with cinnamaldehyde can synergistically enhance the performance and broaden antifungal spectrum as well. Therefore, EDTA is recommended to serve as the additive ingredient into the gallate/fungicide system.

### Example 6

### Antifungal Activity of Antioxidants (Propyl Gallate and Octyl Gallate) to Inhibit Paper Decay Fungi

The fungal strains used were Aspergillus terreus, Aspergillus niger and Chaetomium globosum.

The test of antifungal activity on paper was based on the rule of CNS 2690 and TAPPI T487 cm-93. The mycelia of fungi strains were transferred to PDA containing Petri dishes respectively. After incubating at 28° C. for 10 days, the spores of fungi were scraped up using platinum thread in laminar flow and put into 10 ml sterile water (1×10⁵ CFU/ml), mixing well by shaking, and filtering to get single type spore suspension. The filter paper was cut into 5×5 cm². The chemicals (propyl gallate and octyl gallate) diluted in ethanol were spread on the filter paper. After ethanol evaporating, the filter paper was put on PDA containing Petri dish. 1 ml of spore suspension was evenly spread on the filter paper and incubated for 14 days in an incubator. The antifungal properties of test chemicals were evaluated by observing the growth area of fungi and measuring the percent inhibition ratio of the growth area.

The antifungal activities against paper fungi of test chemicals were shown in Table 7. The inhibition ratio of octyl gallate against A. terreus at the concentration of 100 μg/cm² was 51%. When the concentration was raised to be 400 μg/cm², the antifungal activity could reach 94%. The inhibition ratio of octyl gallate against A. niger at the concentration of 100 μg/cm² was 72%. When the concentration was raised to be 400 μg/cm², the antifungal activity could reach 99%. As for C. globosum, the inhibition ratio of propyl gallate at the concentration of 100 μg/cm² did not show any antifungal activity; however, when the concentration raised to be 400 μg/cm², the antifungal activity reached 100%. On the other hand, the inhibition ratio of octyl gallate against C. globosum was 100% at the concentration of 100 μg/cm².

TABLE 7
Percent inhibition ratio of test chemicals against paper fungi at the
concentration of 100 μg/cm² and 400 μg/cm².

| Chamicals | Fungi | | |
|---|---|---|---|
| (ug/cm²) | A. terreus | A. niger | C. globosum |
| Propyl gallate | 0 ± 0 | 0 ± 0 | 0 ± 0 |
| (100 μg/cm²) | | | |
| Propyl gallate | 0 ± 0 | 0 ± 0 | 100 ± 0 |
| (400 μg/cm²) | | | |
| Octyl gallate | 51 ± 4.6 | 72 ± 7.6 | 100 ± 0 |
| (100 μg/cm²) | | | |
| Octyl gallate | 94 ± 8.5 | 99 ± 1.0 | 100 ± 0 |
| (400 μg/cm²) | | | |

What is claimed is:

1. An anti-fungal composition for inhibition of lignocellulosic material decay, comprising a compound of formula I 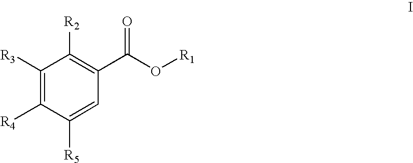
wherein R₁ is (CH₂)ₙCH₃, n=2˜11;
R₂ is H or OH; R₃ is OCH₃, H or OH; R₄ is OCH₃, H or OH; and R₅ is H or OH.

2. The composition of claim 1, wherein n=7; R₂ is H; R₃ is OH; R₄ is OH; and R₅ is OH.

3. The composition of claim 1, wherein n=2; R₂ is H; R₃ is OH; R₄ is OH; and R₅ is OH.

4. The composition of claim 1, which further comprises cinnamaldehyde.

5. The composition of claim 1, which further comprises diaminoethanetetraacetic acid.

6. An anti-fungal composition for inhibition of lignocellulosic material decay, comprising a compound of formula II 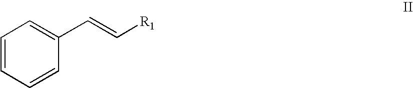
wherein R₁ is CH₂OH, CH₂OCOCH₃, CHO or COOH.

7. The composition of claim 6, wherein R₁ is CHO.

8. The composition of claim 6, which further comprises eugenol.

9. The composition of claim 6, which further comprises diaminoethanetetraacetic acid.

10. A method for inhibition of lignocellulosic material decay caused by fungal infection, which comprises administering to a lignocellulosic material an effective amount of a composition, comprising a compound of formula I 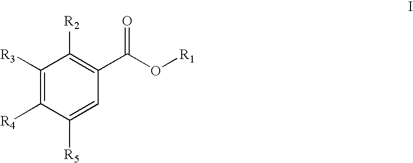
wherein R₁ is (CH₂)ₙCH₃, n=2˜11;
R₂ is H or OH; R₃ is OCH₃, H or OH; R₄ is OCH₃, H or OH; and R₅ is H or OH.

11. The method of claim 10, wherein n=7; R₂ is H; R₃ is OH; R₄ is OH; and R₅ is OH.

12. The method of claim 10, wherein n=2; R₂ is H; R₃ is OH; R₄ is OH; and R₅ is OH.

13. The method of claim 10, wherein the composition further comprises cinnamaldehyde.

14. The method of claim 10, wherein the composition further comprises diaminoethanetetraacetic acid.

15. The method of claims 10, wherein the lignocellulosic material is an antique made by lignocellulosic materials.

16. The method of claims 10, wherein the fungal infection is caused by fungi in the phyla of Basidiomycota or Ascomycota.

17. A method for inhibition of lignocellulosic material decay caused by fungal infection, which comprises administering to a lignocellulosic material an effective amount of a composition, comprising a compound of formula II 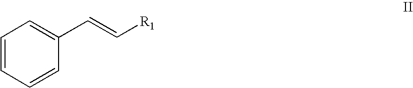
wherein R₁ is CH₂OH, CH₂OCOCH₃, CHO or COOH.

18. The method of claim 17, wherein R₁ is CHO.

19. The method of claim 17, wherein the composition further comprises eugenol.

20. The method of claim 17, wherein the composition further comprises diaminoethanetetraacetic acid.

21. The method of claims 17, wherein the lignocellulosic material is an antique made by lignocellulosic materials.

22. The method of claims 17, wherein the fungal infection is caused by fungi in the phyla of Basidiomycota or Ascomycota.
